(19) United States
(12) Patent Application Publication
(10) Pub. No.: US 2026/0132839 A1
(43) Pub. Date: May 14, 2026

(54) LIGHTWEIGHT AND FLEXIBLE LOAD BEARING SHACKLE UTILIZING A PLURALITY OF LOOPS OF FIBER ROPE AS A BOW

(71) Applicant: Chant Engineering Co. Inc., New Britain, PA (US)

(72) Inventors: Philip Chant, Perkasie, PA (US); Mason Chant, Perkasie, PA (US); Stephen Grzeczkowski, Chalfont, PA (US)

(21) Appl. No.: 19/038,509

(22) Filed: Jan. 27, 2025

Related U.S. Application Data
(60) Provisional application No. 63/719,014, filed on Nov. 11, 2024.

(51) Int. Cl. F16G 15/06

(52) U.S. Cl. CPC F16G 15/06

(57) ABSTRACT

A lightweight and flexible load bearing shackle that is configurable in operation. The shackle includes a bow made of a plurality of loops of synthetic fiber rope (e.g., polypropylene, nylon, polyester, polyethylene, Aramid, acrylic, co-polymer fibers) within a sheathing. The sheathing is secured together to form a receptacle (opening) in each leg of the bow that has a boot located therewithin. The sheathing and the boot may be secured together using a cover.

The boot may include an enclosed channel that the sheathing is routed through to secure the bow and the boot. The boots include threaded holes passing therethrough where one threaded hole is larger than the other. A connection pin having two threaded portions (one portion larger than the other) separated by a non-threaded portion is used to secure to the boots and maintain the ends a certain distance apart (length on non-threaded portion).

### BACKGROUND

Shackles are devices that may provide a quick, convenient, secure and strong connection. They may also be capable of quickly and conveniently being disconnected.

Shackles typically include a bow and a connection pin. The bow may be “U” shaped so as to have an open end and a closed end. The bow typically includes holes on each of the legs thereof so to receive the connection pin. The connection pin passes through each of the holes to seal off the open end of the bow and is then secured thereto. The connection pin may include one end that is larger than the holes so as to not pass therethrough. The other end may pass through the holes and then be secured within the bow in some fashion. For example, the other end of the connection pin may be threaded so as to receive a nut in order to secure the pin within the bow. Alternatively, the other end of the connection pin may include a hole formed therein that can receive a pin to secure the connection pin within the bow.

The connection pin may be removed from the bow so as to open the shackle so that the bow may be placed on an item. The connection pin may then be secured to the bow so as to secure the shackle to the item. Shackles vary in size, shape, orientation and configuration depending on what they are used for. Shackles may be used in lifting operations to connect an object to a lifting apparatus, such as a crane (often referred to as load bearing shackles). The manner in which the shackles are utilized to connect the object to the lifting apparatus may vary depending on numerous factors including, but not limited to, type of lifting apparatus used, and size and weight of object to be lifted. Load bearing shackles are typically made with a heavy duty, strong and durable material, such as, steel.

Cranes and other industrial equipment are used to hoist and move cargo, equipment and other heavy objects (hereinafter simply referred to as “load” for simplicity). The cranes may utilize cables and a plurality of pullies to lift and move the loads. The cables utilized were typically metal (e.g., steel) cables that were very strong and durable. The steel cables are very heavy and could be susceptible to corrosion (e.g., rusting). Synthetic rope cables have begun to be used as alternatives to the steel cables. The synthetic rope cables are made from hi-tech polyethylene, synthetic rope and are lighter weight and more flexible than steel cables. The lighter weight of the synthetic rope cables may make handling easier and also may enable heavier loads to be lifted (as the weight of the cable is included in the maximum load calculation of the lifting apparatus).

The weight associated with load bearing shackles may make them hard to handle, and in certain circumstances may require a lifting apparatus to be put in place. Furthermore, the weight factures into the maximum load calculations. Moreover, the rigid form of the load bearing shackles makes them tough to utilize in certain situations, for example, where space is limited. What is needed is a lightweight load bearing shackle that is strong, durable and safe to use. Moreover, a load bearing shackle that is flexible so that it can be utilized in various situations, including where space is limited is desired. Furthermore, a corrosion resistant load bearing shackle is preferable.

### BRIEF DESCRIPTION OF THE DRAWINGS

The features and advantages of the various embodiments will become apparent from the following detailed description in which:

FIG. 1 illustrates an exploded view of an example lightweight load bearing shackle, according to one embodiment;

FIGS. 2A-D illustrate various views of an example boot of an example lightweight load bearing shackle, according to one embodiment;

FIGS. 3A-D illustrate various views of an example cover of an example lightweight load bearing shackle, according to one embodiment;

FIGS. 4A-D illustrate various views of an example pin of an example lightweight load bearing shackle, according to one embodiment;

FIGS. 5A-D illustrate various views of an example lightweight load bearing shackle, according to one embodiment;

FIGS. 6A-B illustrate perspective and top views of an example lightweight load bearing shackle without the sling, according to one embodiment;

FIG. 7 illustrates an exploded view of an example lightweight load bearing shackle, according to one embodiment;

FIGS. 8A-D illustrate various views of an example boot of an example lightweight load bearing shackle, according to one embodiment;

FIGS. 9A-E illustrate various views of an example pin of an example lightweight load bearing shackle, according to one embodiment;

FIGS. 10A-D illustrate various views of an example lightweight load bearing shackle, according to one embodiment; and

FIGS. 11A-B illustrate perspective and top views of an example lightweight load bearing shackle without the sling, according to one embodiment.

### DETAILED DESCRIPTION

A lightweight load bearing shackle that is corrosion resistant and still provides the strength and durability required to lift loads is provided. The shackle includes a bow that is made of a fiber rope (e.g., synthetic fiber). The fiber rope may be made of, for example, polypropylene, nylon, polyesters (e.g. PET, LCP, Vectran), polyethylene (e.g. Dyneema and Spectra), Aramids (e.g. Twaron, Technora and Kevlar) and acrylics (e.g. Dralon). Some fiber ropes may be constructed of mixtures of several fibers or use co-polymer fibers. The fibers making up the rope may be straight, braided and/or twisted. The number, orientation and configuration of the fibers may vary depending on the type of light weight load bearing shackle it is too be used in. The fibers and/or the fiber rope may be coated.

The fiber rope may be contained within a sheathing. The bow may include a plurality of loops of fiber rope or may possibly include a single loop of the fiber rope. The bow may be shaped so as to have two opposing legs (e.g., U shaped) and include a hole formed in some fashion on each of the legs to receive a connection pin so as to secure an open end of the shackle. The hole may be provided by, or reinforced in, various manners in order to support the connection pin. For example, an insert, gromet, eyelet or the like that is made of a heavy-duty material such as steel may be used to support the connection pin. A connection pin may pass through the holes on each leg and be secured therein. As the fiber rope bow is flexible, the connection pin may include some type of support to maintain the legs a certain distance apart.

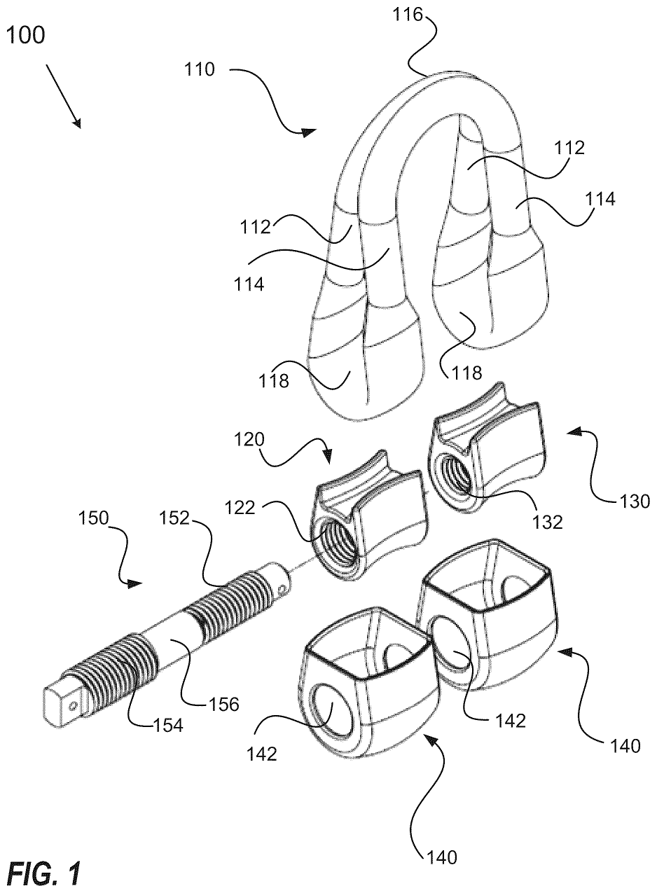

FIG. 1 illustrates an exploded view of an example lightweight load bearing shackle 100. The shackle 100 includes a sling 110, a first boot and a second boot 120, 130, a pair of covers 140, and a pin 150. The sling 110 may be a plurality of fibers secured within a sheathing (the fibers are not illustrated but would be located within the sheathing). The sheathing is then folded onto itself to form a U-shape where first and second sides 112, 114 of the sheathing abut each other and are secured together. The sides 112, 114 are not secured at the ends of the U shape so as to form openings 118 therein for receiving the boots 120, 130. A central portion of the U shape may include a secondary sheathing 116 to further secure the sides 112, 114 together.

The boots 120, 130 are shaped so as to receive the first and second sides 112, 114 of the openings 118 along the exterior surface thereof. The boots 120, 130 include threaded openings 122, 132 therethrough to receive the threaded pin 150 therein. The size of the threaded opening 122 is larger than the threaded opening 132. The covers 140 are to be placed over the boots 120, 130 when the sling 110 is wrapped around the boots 120, 130 to secure the sling 110 therein. The covers 140 include holes 142 in alignment with the threaded holes 122, 132 when placed thereover to provide access to the threaded holes 122, 132 allow the pin 150 to pass therethrough into the threaded openings in the boot 120.

The pin 150 includes a first threaded portion 152 and a second threaded portion 154 (larger than the first 152) separated by a non-threaded portion 156. The first threaded portion 152 is sized for the threaded opening 132 and the second threaded portion 154 is sized for the threaded opening 122. The non-threaded portion 156 is located between the boots 120, 130 and will keep the two ends of the shackle 100 separated when the first threaded portion 152 is screwed into the threaded opening 132 and the second threaded portion 154 is screwed into the threaded opening 122.

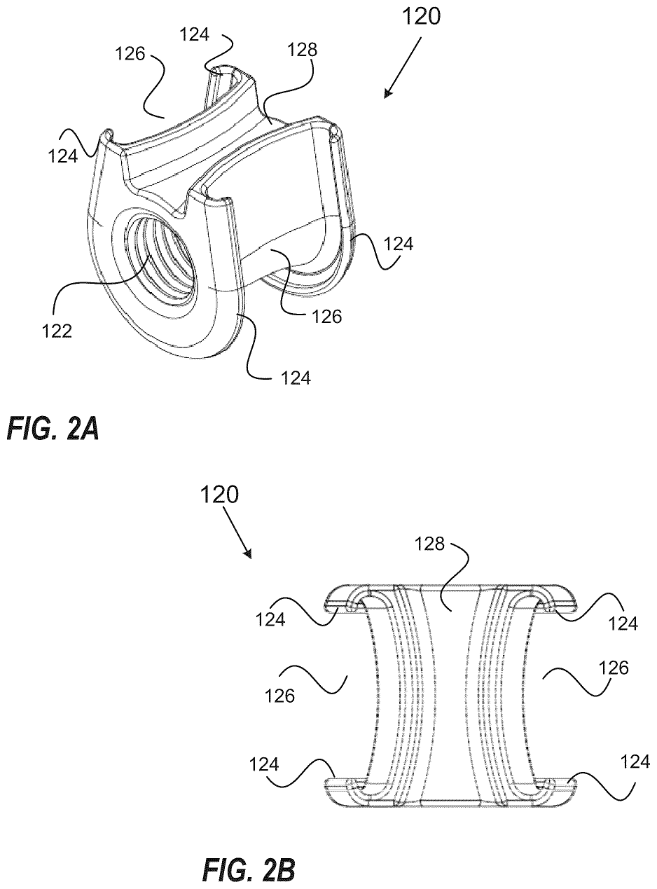

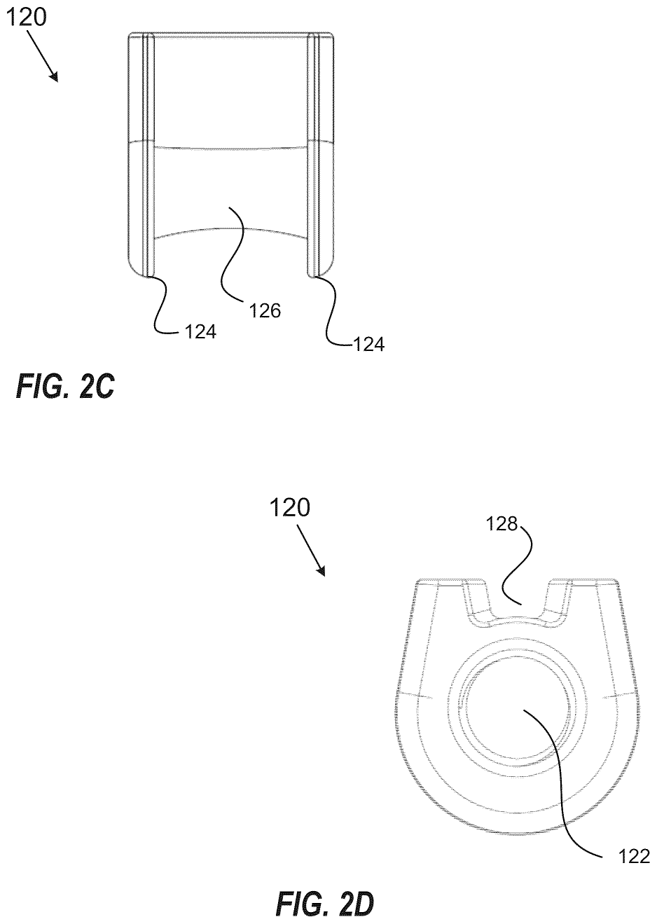

FIGS. 2A-D illustrate various views of an example boot 120 (FIG. 2A is a perspective view, FIG. 2B is a top view, FIG. 2C is a front view and FIG. 2D is a side view). The boot 120 includes the threaded hole 122 through a center thereof for receiving the pin 150. The exterior of the boot 120 includes sidewalls 124 along each edge to form a channel 126 to assist in maintaining the sling 110 therewithin. The boot 120 is wider along a bottom portion and narrows at an upper portion where the first and second sides 112, 114 are received. The channel 126 does not extend to an upper portion 128 as the first and second sides 112, 114 do not engage therewith. It should be noted that the boot 130 is similar to the boot 120 except that the threaded hole 132 is smaller than the threaded hole 122.

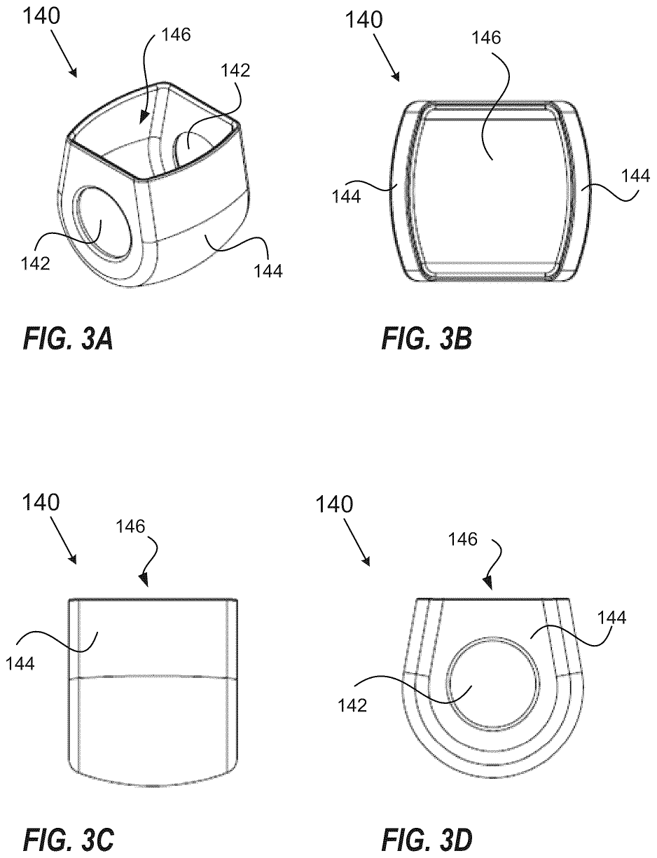

FIGS. 3A-D illustrate various views of an example cover 140 (FIG. 3A is a perspective view, FIG. 3B is a top view, FIG. 3C is a front view and FIG. 3D is a side view). The cover 140 has an exterior 144 that is shaped similarly to the shape of the boots 120, 130 with an open top 146 so the cover can be placed over and provide a tight fit on the boots 120, 130. The cover 140 includes holes 142 formed in each side of the exterior 144 in alignment with the threaded holes 122, 132 so that the pin 150 can pass therethrough.

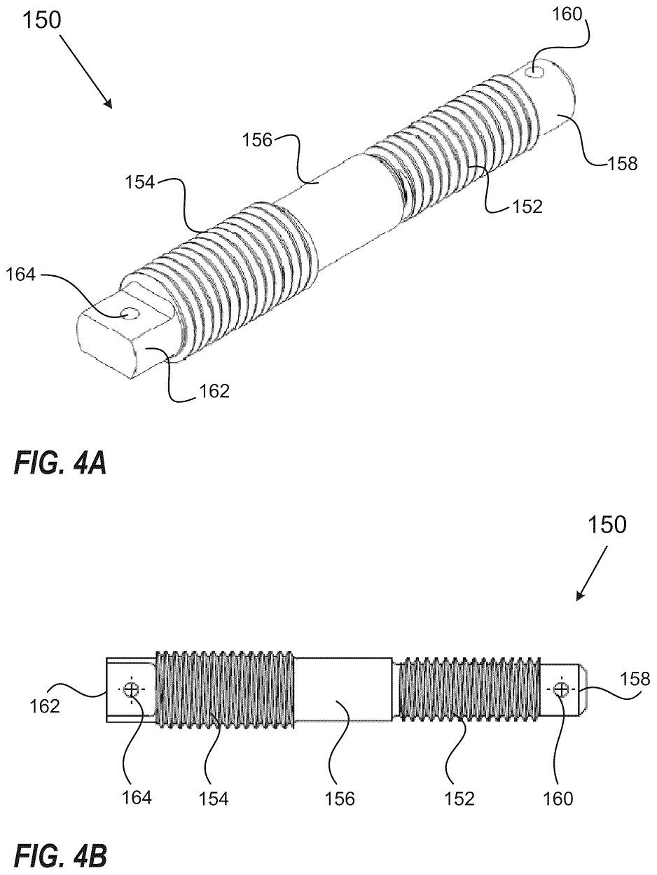

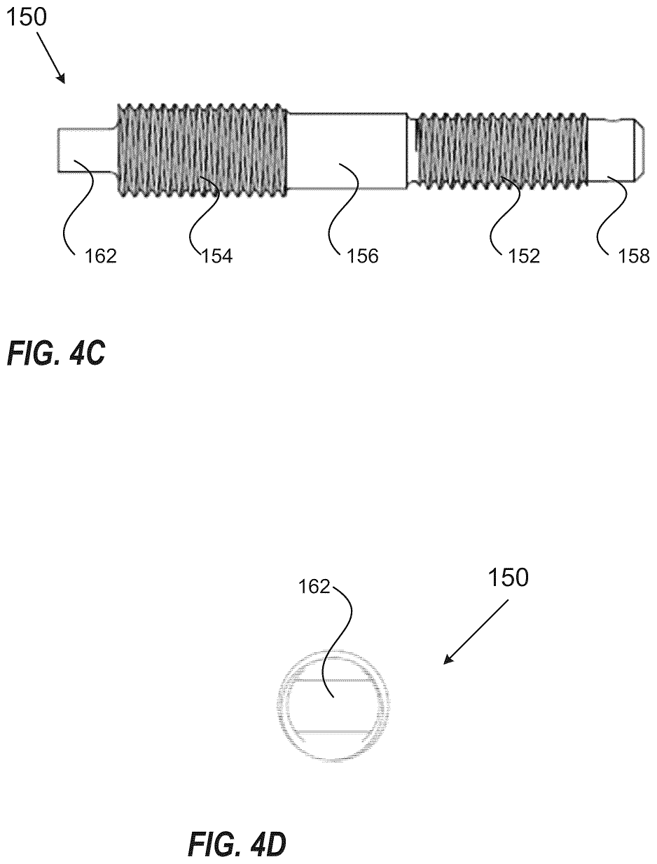

FIGS. 4A-D illustrate various views of an example pin 150 (FIG. 4A is a perspective view, FIG. 4B is a top view, FIG. 4C is a front view and FIG. 4D is a left-side view). The pin 150 includes a first threaded portion 152 and a second threaded portion 154 (larger than the first 152) separated by a non-threaded portion 156. A first side 158 of the pin 150 may extend past the first threaded portion 152 and include a hole 160 therein to enable, for example, a pin (e.g., cotter pin) to pass therethrough to, for example, further secure the pin 150 in the shackle 100 in operation. A second side 162 of the pin 150 may extend past the second threaded portion 154 and be configured to enable turning (illustrated as a flat portion). The second side 162 may also include a hole 164 therein to enable, for example, a pin (e.g., cotter pin) or a cable to pass therethrough. A pin may be used to, for example, further secure the pin 150 in the shackle 100 in operation. A cable may be used to, for example, secure the pin 150 to the sling 110 so that the pin 150 and the sling 110 stay together.

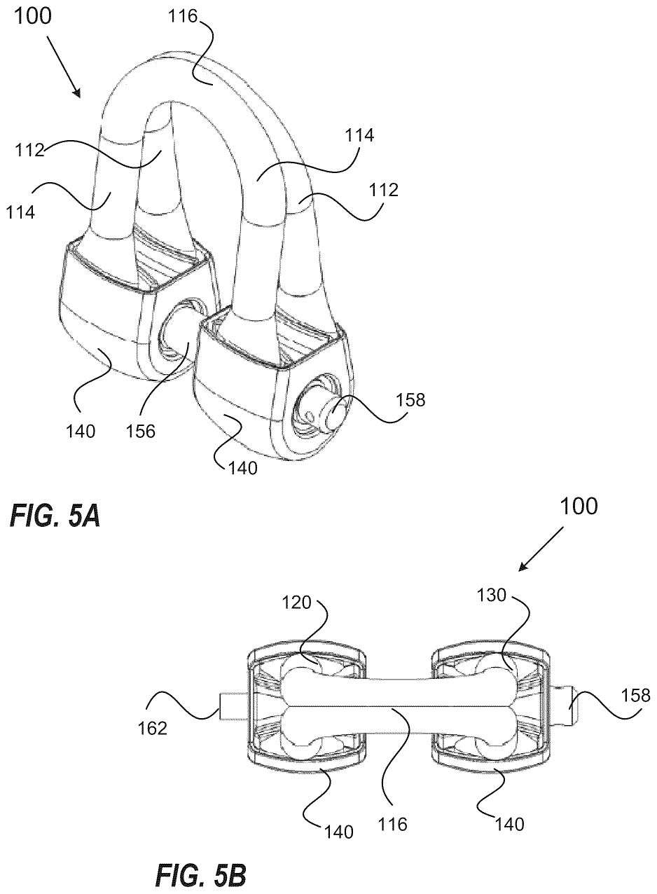

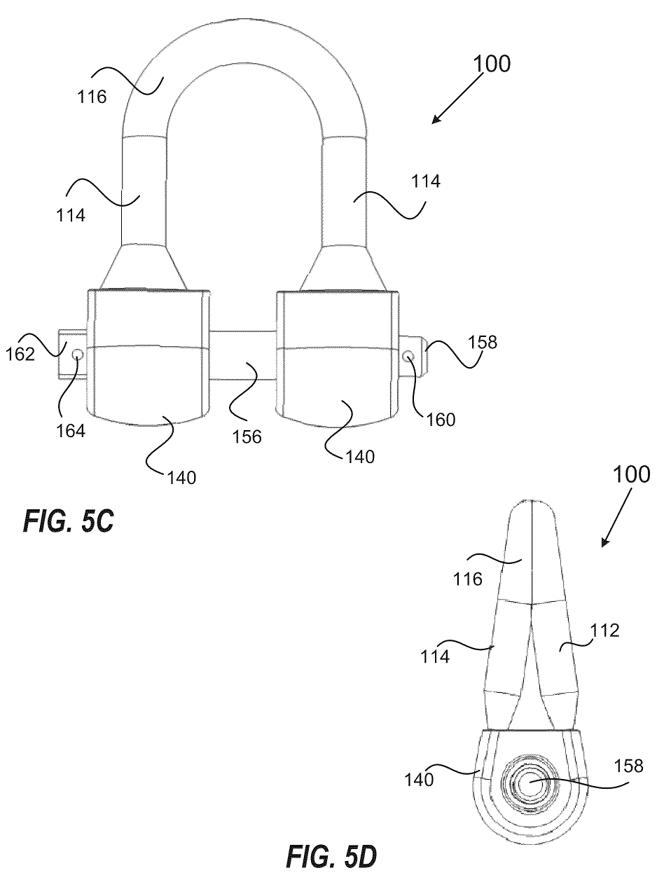

FIGS. 5A-D illustrate various views of an example shackle 100 (FIG. 5A is a perspective view, FIG. 5B is a top view, FIG. 5C is a front view and FIG. 5D is a right-side view). The first and second ends 112, 114 of the sling 110 may be secured together along a substantial portion thereof with the exception of the ends that are not secured so as to create the openings 118 that are wrapped around the boots 120, 130 prior to the covers 140 being secured thereon. An upper portion of the sling 110 may be secured within an additional sheathing 116 (both sides of the slings are illustrated but would not be seen if located within an additional sheathing). The pin 150 is secured within the boots 120, 130 so that the middle portion 156 is located therebetween to keep the ends of the shackle 100 apart.

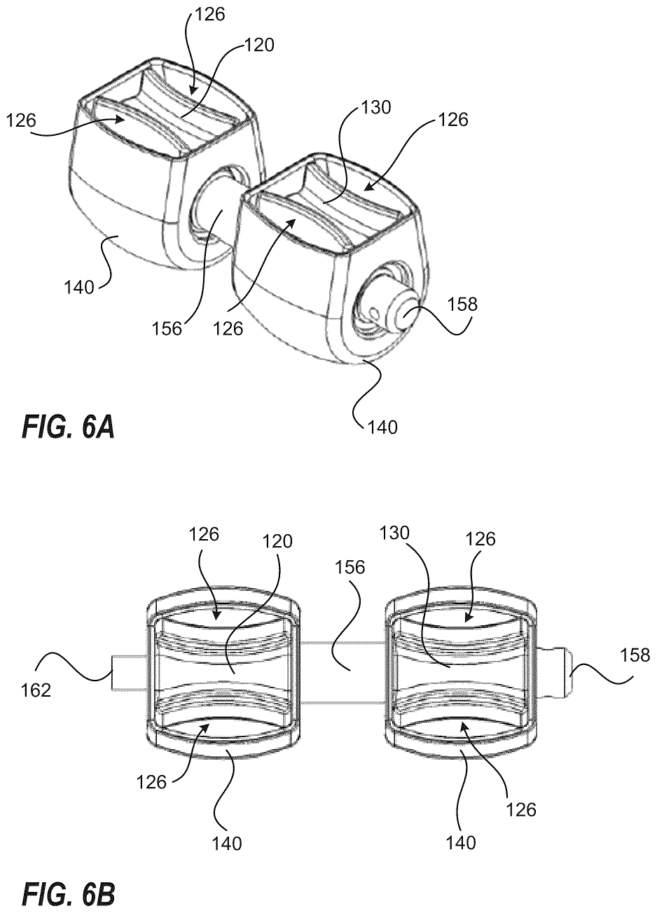

FIGS. 6A-B illustrate perspective and top views of an example shackle 100 without the sling 110. As illustrated, you can see the boots 120, 130 within the covers 140 and where the opening 118 of the sling 110 would be located within the channels 126 of the boots 120, 130 and secured in place by the covers 140.

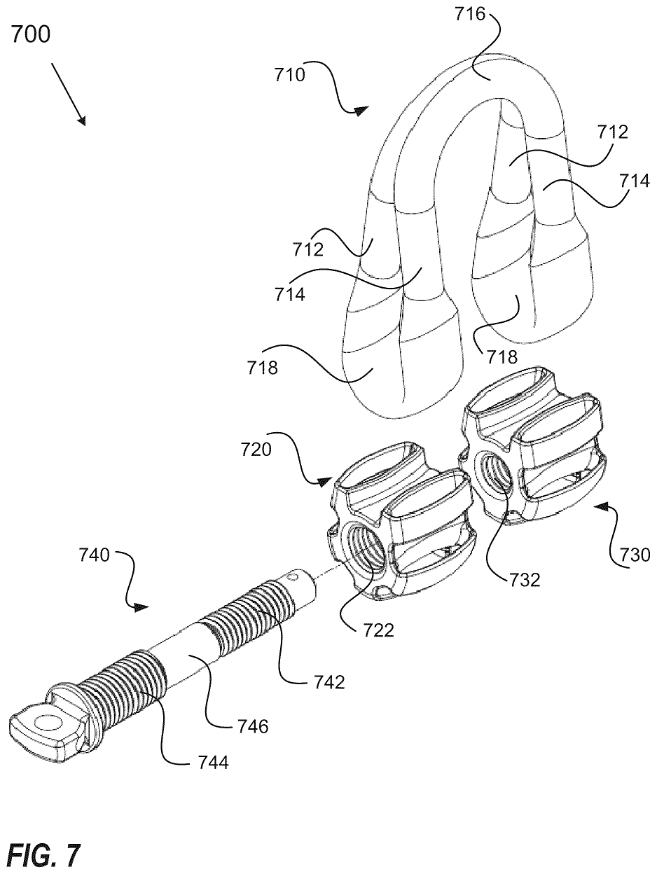

FIG. 7 illustrates an exploded view of an example lightweight load bearing shackle 700. The shackle 700 includes a sling 710 (may be same as sling 110), a first boot and a second boot 720, 730, and a pin 740. The sling 710 may be a plurality of fibers secured within a sheathing (the fibers are not illustrated but would be located within the sheathing). The sheathing is then folded onto itself to form a U-shape where first and second sides 712, 714 of sheathing abut each other and are secured together. The sides 712, 714 are not secured at the ends of the U shape so as to form openings 718 therein that are secured around the boots 720, 730. A central portion of the U shape may include a secondary sheathing 716 to further secure the sides 712, 714 together.

The boots 720, 730 are shaped so as to receive the first and second legs 712, 714 of the openings 718 of the sling 710 along the exterior surface thereof. The boots 720, 730 include threaded openings 722, 732 therethrough to receive the threaded pin 740 therein. The size of the threaded opening 722 is larger than the threaded opening 732. The pin 740 includes a first threaded portion 742 and a second threaded portion 744 (larger than the first 742) separated by a non-threaded portion 746. The first threaded portion 742 is sized for the threaded opening 732 and the second threaded portion 744 is sized for the threaded opening 722. The non-threaded portion 746 is located between the boots 720, 730 and will keep the two ends of the shackle 700 separated when the first threaded portion 742 is screwed into the threaded opening 732 and the second threaded portion 744 is screwed into the threaded opening 722.

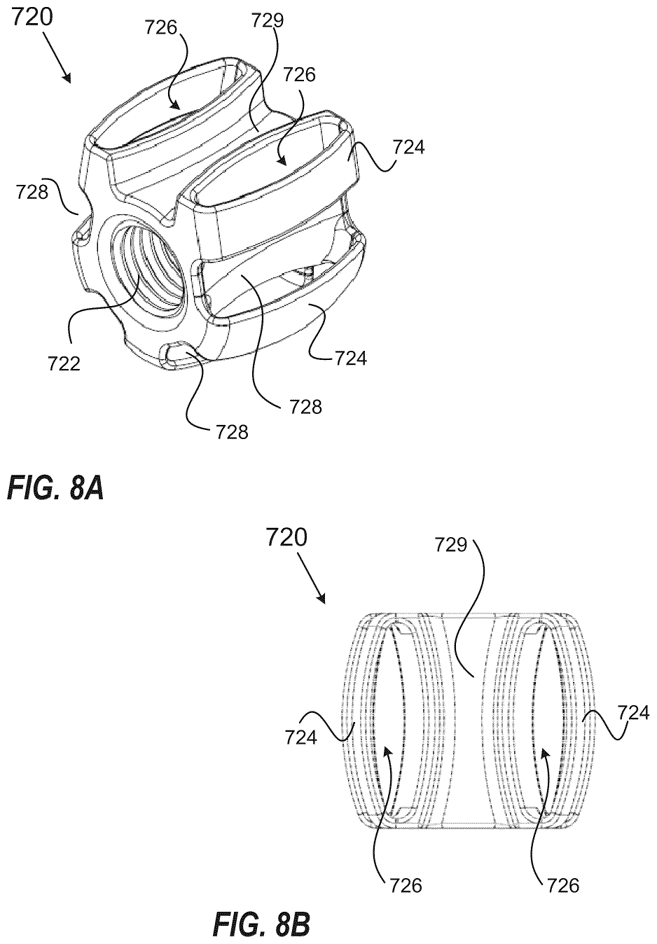

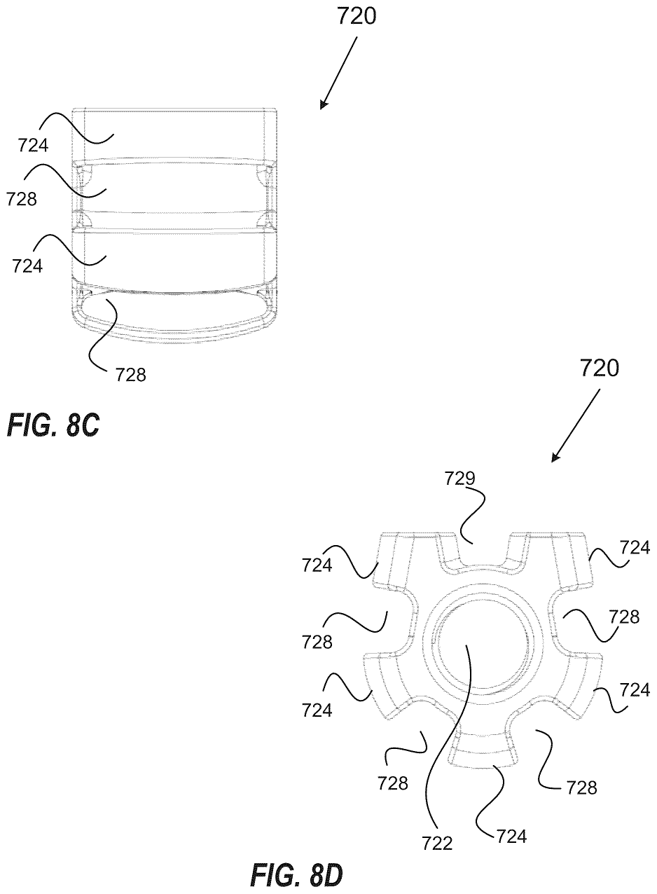

FIGS. 8A-D illustrate various views of an example boot 720 (FIG. 8A is a perspective view, FIG. 8B is a top view, FIG. 8C is a front view and FIG. 8D is a side view). The boot 720 includes the threaded hole 722 through a center thereof. The exterior of the boot 720 includes sidewalls (not labeled) along each edge to form a channel 726 to assist in maintaining the sling 710 therewithin. A plurality arms 724 extend from sidewall to sidewall at different points to enclose the channel 726 and secure the sling 710 therewithin (the sling 710 passes under the arms 724) and between each of the arms 724 is an open portion 728. The boot 720 is wider along a bottom portion and narrows at an upper portion where the first and second sides 712, 714 are received. The channel 726 does not extend to an upper portion 729 as the first and second sides 112, 114 do not engage therewith. It should be noted that the boot 730 is similar to the boot 720 except that the threaded hole 732 is smaller than the threaded hole 722.

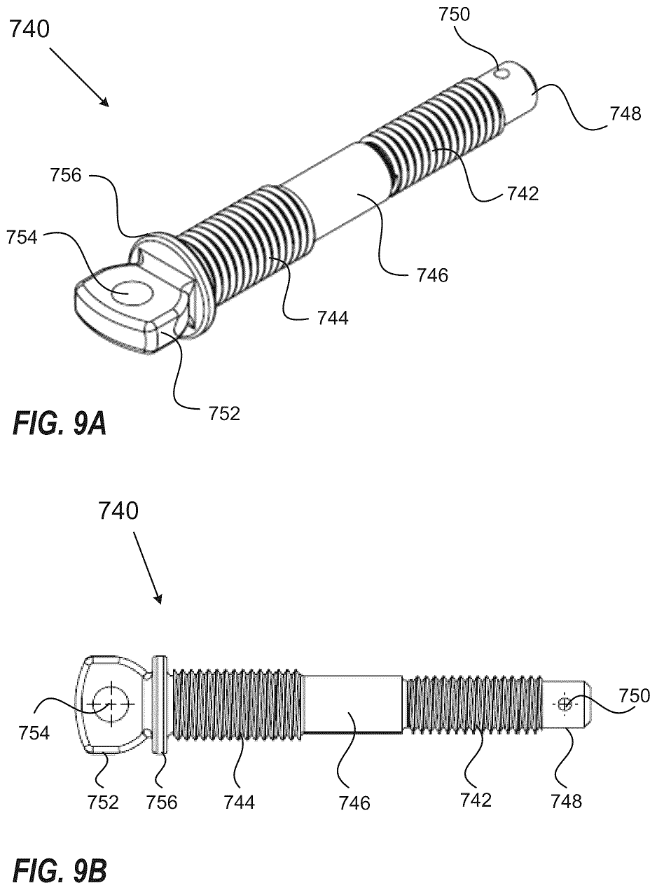

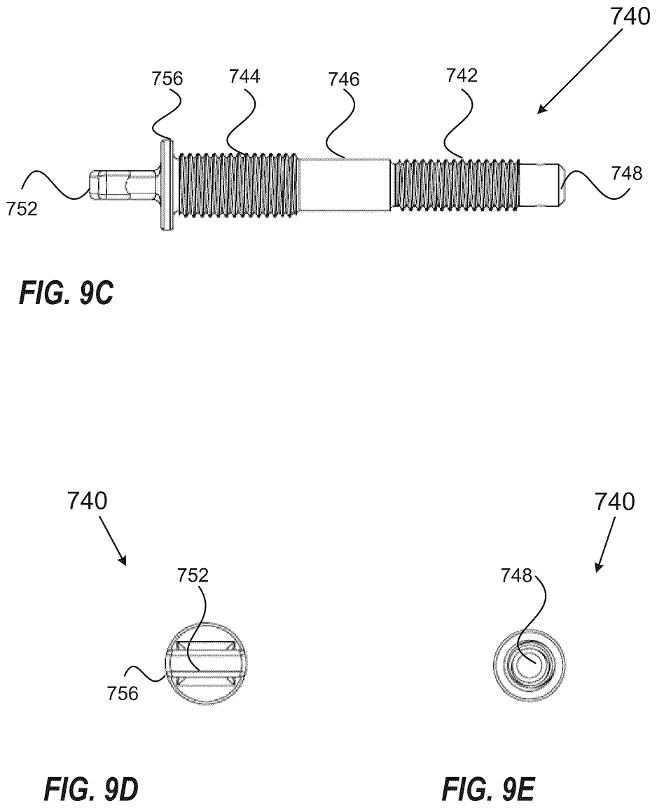

FIGS. 9A-E illustrate various views of an example pin 740 (FIG. 9A is a perspective view, FIG. 9B is a top view, FIG. 9C is a front view, FIG. 9D is a left-side view and FIG. 9E is a right-side view). The pin 740 includes a first threaded portion 742 and a second threaded portion 744 (larger than the first 742) separated by a non-threaded portion 746. A first side 748 of the pin 740 may extend past the first threaded portion 742 and include a hole 750 therein to enable, for example, a pin (e.g., cotter pin) to pass therethrough, for example, to further secure the pin 740 in the shackle 700 in operation. A second side 752 of the pin 740 may extend past the second threaded portion 744 and be configured to enable turning (illustrated as a flanged flat portion). The second side 752 may also include a hole 754 therein to enable, for example, a pin (e.g., cotter pin) or a cable to pass therethrough. A pin may be used to, for example, further secure the pin 740 in the shackle 700 in operation. A cable may be used to, for example, secure the pin 740 to the sling 710 so that the pin 740 and sling 710 stay together. The second side 752 may include an extended circular tab 756 between the second side 752 and the second threaded portion 744. The circular tab 756 may prevent the pin 740 from proceeding through the threaded hole 722.

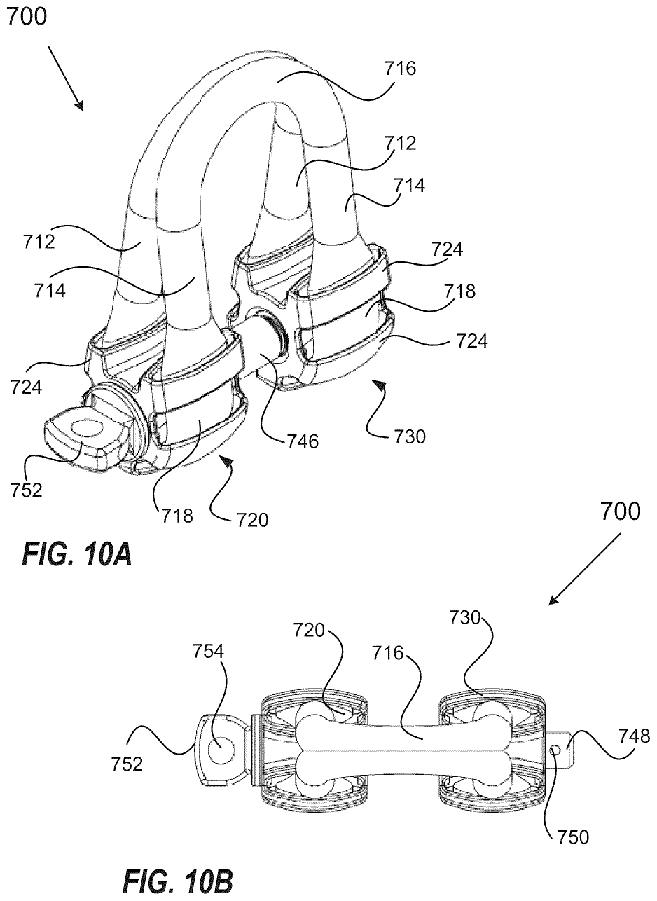

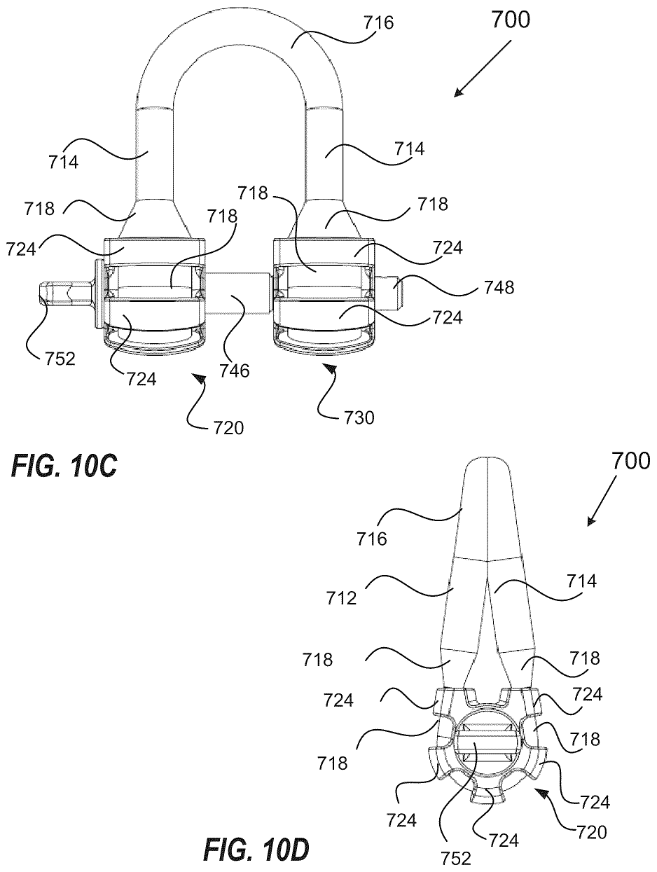

FIGS. 10A-D illustrate various views of an example shackle 700 (FIG. 10A is a perspective view, FIG. 10B is a top view, FIG. 10C is a front view and FIG. 10D is a left-side view). The first and second ends 712, 714 of the sling 710 may be secured together along a substantial portion thereof with the exception of the ends that are not secured so as to create the openings 718 that are wrapped around the boots 720, 730 (within the channels 726 and under the arms 724). An upper portion of the sling 710 may be secured within an additional sheathing 716 (both sides of the slings are illustrated but would not be seen if located within an additional sheathing). The pin 740 is secured within the boots 720, 730 so that the middle portion 746 is located therebetween to keep the ends of the shackle 700 apart.

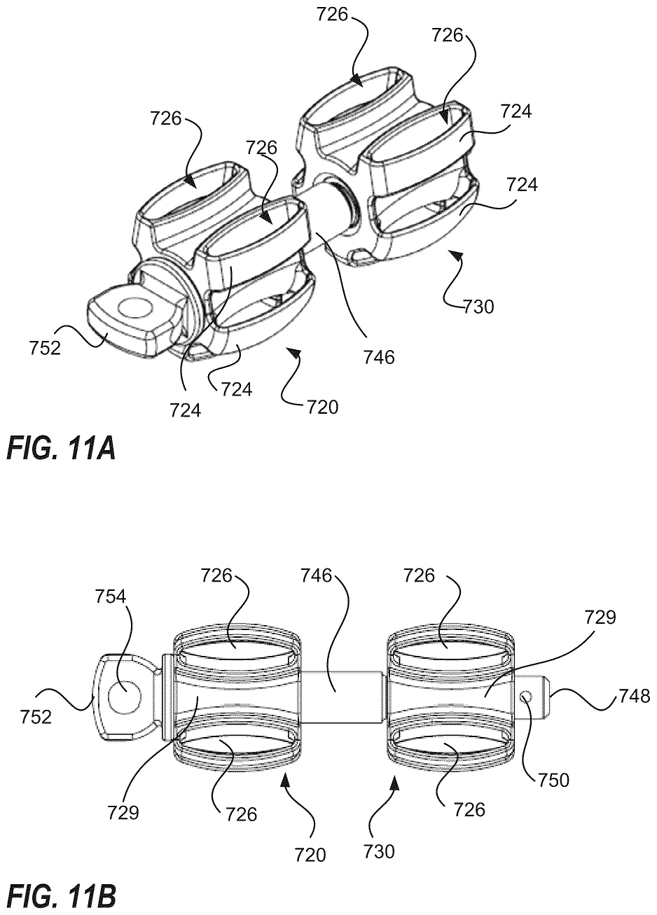

FIGS. 11A-B illustrate perspective and top views of an example shackle 700 without the sling 710. The channels 726 for receiving the ends 718 of the sling 710 are visible.

According to one embodiment, the sling 710 may be fed through the boots 720, 730 as the sling 710 is being created so that the sling 710 is permanently secured thereto. The fibers may be fed through the sheath and the boots 720, 730 at the same time. After the winding of the fibers is complete the sheath may be secured together.

The disclosure included two distinct embodiments but is in no way intended to be limited thereto. Rather, different elements from each embodiment could be mixed (e.g., the pin 150 could be used with the shackle 700, the pin 740 could be used with the shackle 100) without departing from the current scope. Furthermore, components could be added, subtracted, modified, combined or separated from the disclosed embodiments without departing the current scope.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure, or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A lightweight load bearing shackle comprising:
a bow formed from a plurality of loops of fiber rope, wherein the plurality of loops are substantially aligned with one another and are secured together to form a single loop, wherein a first side of the single loop is secured to a second side of the single loop along a center portion of the single loop, wherein the first side and the second side of the single loop are not secured together at a first end and a second end so that the first side of the single loop and the second side of the single loop form a first receptacle at the first end and a second receptacle at the second end;
a first boot located within the first receptacle, wherein the first boot includes a first threaded opening;
a second boot located within the second receptacle, wherein the second boot includes a second threaded opening, wherein the second threaded opening is smaller than the first threaded opening; and
a connection pin having a first threaded portion and second threaded portion separated by a non-threaded portion, wherein the second threaded portion is smaller than the first threaded portion, and wherein the first threaded portion is to be threaded into the first threaded opening and the second threaded portion is to be threaded into the second threaded portion and the non-threaded portion is to be located therebetween to keep the first and second receptacles a distance equal to length of the non-threaded portion apart.

2. The shackle of claim 1, wherein the fiber rope includes fibers selected from at least one of polypropylene, nylon, polyesters, polyethylene, Aramids and acrylics.

3. The shackle of claim 1, wherein the fiber rope includes fibers selected from at least one of straight, braided and twisted.

4. The shackle of claim 1, further comprising a sheathing to house the single loop.

5. The shackle of claim 1, further comprising a sheathing to house the plurality of loops of fiber rope and align the plurality of loops with one another and secure them together as the single loop.

6. The shackle of claim 5, wherein the sheathing holding the single loop is folded in half to form a substantially “U” shaped bow having a first leg and a second leg, wherein a first side of the substantially “U” shaped bow is secured to a second side of the substantially “U” shaped bow along a center portion of the substantially “U” shaped bow, wherein the first side and the second side of the substantially “U” shaped bow are not secured together at an end of the first leg and an end of the second leg of the substantially “U” shaped bow so the first side and the second side form the first receptacle at the end of the first leg and the second receptacle at the end of the second leg.

7. The shackle of claim 6, wherein the first side and the second side of the substantially “U” shaped bow is secured along the center portion of the substantially “U” shaped bow via stitching.

8. The shackle of claim 1, wherein the first side and the second side of the single loop are secured together along the center portion with a sheathing.

9. The shackle of claim 1, wherein the first boot and the second boot have a channel formed on an exterior surface for receiving the first and the second receptacles respectively.

10. The shackle of claim 9, further comprising a first cover to be secured over the first boot to secure the first receptacle within the channel of the first boot and a second cover to be secured over the second boot to secure the second receptacle within the channel of the second boot.

11. The shackle of claim 1, wherein the first boot and the second boot have a channel formed on an exterior surface for receiving the first and the second receptacles respectively, wherein the channels include a plurality of arms sealing the channel and securing the first and the second receptacles in the respective first and the second boot.

12. The shackle of claim 11, wherein the single loop is fed through the first boot and the second boot respectively before the first side and the second side of the single loop are secured together.

13. The shackle of claim 1, wherein flexibility of the fiber rope enables configuration of the bow to be adjusted and modified in operation.

14. A method of making a lightweight load bearing shackle, the method comprising:
wrapping a fiber rope into a plurality of loops;
placing the plurality of loops into a sheathing;
securing a first side of the sheathing to a second side of the sheathing along a center portion thereof, wherein the first side and the second side not secured together at a first end create a first receptacle and the first side and the second side not secured together at a second end create a second receptacle;
placing a first boot within the first receptacle so that the first receptacle is located within a first channel formed in an exterior of the first boot;
placing a second boot within the second receptacle so that the second receptacle is located within a second channel formed in an exterior of the second boot; and
securing a pin having a first threaded portion and a second threaded portion separated by a non-threaded portion to a first threaded hole in the first boot and a second threaded hole in the second boot, wherein the securing the pin includes passing the first threaded portion of the pin through the second threaded portion in the second boot and screwing the first threaded portion into the first threaded hole and the second threaded portion into the second threaded hole.

14. (canceled)

15. The method of claim 14, further comprising:
placing a first cover over the first boot to secure the first receptacle within the first channel; and
placing a second cover over the second boot to secure the second receptacle within the second channel.

16. The method of claim 14, wherein the first and the second channels of the first and the second boots include a plurality of arms extending from a first edge thereof to a second edge thereof to partially enclose the first and the second channel in order to secure the first and the second receptacles in the respective first and second channels.

17. The method of claim 16, wherein
the placing the first boot within the first receptacle includes locating the first receptacle within the first channel under the plurality of arms; and
the placing the second boot within the second receptacle includes locating the second receptacle within the second channel under the plurality of arms.

18. A method of making a lightweight load bearing shackle, the method comprising:
wrapping a fiber rope into a plurality of loops that pass through a first boot, a second boot and a sheathing located between the first boot and the second boot so as to form a single loop of fiber rope loops having the first boot at a first end and the second boot at a second end and the sheathing therebetween;
securing a first side of the sheathing to a second side of the sheathing along a center portion thereof; and
securing a pin having a first threaded portion and a second threaded portion separated by a non-threaded portion to a first threaded hole in the first boot and a second threaded hole in the second boot.

19. The method of claim 18, wherein the securing the pin includes passing the first threaded portion of the pin through the second threaded portion in the second boot and screwing the first threaded portion into the first threaded hole and the second threaded portion into the second threaded hole.

20. The method of claim 18, wherein the first boot and the second boot include a secured channel around an exterior thereof and the fiber rope is routed therethrough.
